(19) United States
(12) Patent Application Publication
(10) Pub. No.: US 2026/0187758 A1
(43) Pub. Date: Jul. 2, 2026

(54) PROCESSING APPARATUS FOR ACCELERATING CONVOLUTION OPERATIONS ACCORDING TO A PIXEL-MAPPING METHOD AND OPERATION METHOD THEREOF

(71) Applicant: SEOUL NATIONAL UNIVERSITY R&DB FOUNDATION, Seoul (KR)

(72) Inventors: Jae-Joon KIM, Seoul (KR); Jihoon PARK, Seoul (KR)

(21) Appl. No.: 19/436,037

(22) Filed: Dec. 30, 2025

(30) Foreign Application Priority Data
Dec. 31, 2024 (KR) 10-2024-0202637
Dec. 9, 2025 (KR) 10-2025-0193852

(51) Int. Cl. G06T 5/20; G06T 7/246; G06V 10/77

(52) U.S. Cl. CPC G06T 5/20; G06T 7/246; G06V 10/7715

(57) ABSTRACT

According to one embodiment, a processing apparatus for accelerating convolution operations comprises a memory array in which a plurality of elementary processing unit are arranged in an array structure, and an operation unit configured to temporarily store feature-map data, divide the feature-map data into predetermined units along a channel-axis direction according to a pixel-first mapping method, and deliver the divided data to the memory array in a manner of shifting the data according to a position of a kernel.

### CROSS-REFERENCE TO RELATED APPLICATION

This application is based on and claims priority under 35 U.S.C. § 119 to Korean Patent Application No. 10-2025-0193852, filed on Dec. 9, 2025, in the Korean Intellectual Property Office and to Korean Patent Application No. 10-2024-0202637, filed on Dec. 31, 2024, in the Korean Intellectual Property Office, the disclosure of which is incorporated by reference herein in its entirety.

### BACKGROUND

### Technical Field

The present invention relates to a processing apparatus for accelerating convolution operations according to a pixel-mapping method and an operation method thereof.

### Background Art

A convolution operation is an operation mainly used in image processing and CNN (Convolution Neural Network), in which a kernel (or filter) is overlapped on a specific region of input data (an image), and multiplication-and-addition operations are performed to extract features. A kernel is typically a small matrix such as 3×3 or 5×5, and performs various roles such as edge detection, blurring, and feature-map extraction. When the kernel is applied at a certain position of the input data or a feature map output through a convolution operation of a previous layer and the operation is performed, a feature map is generated as an output by repeatedly applying the kernel over the entire region while moving one step at a time (stride).

In a hardware accelerator for performing such a convolution operation, in order to perform convolution efficiently, the same pixel must be reused without being read multiple times. To this end, a conventional technique is known in which a line buffer is used to store several consecutive rows of an input image in a memory and supply a data window of kernel size at every clock cycle.

For example, in the case of a 3×3 kernel, the line buffer maintains at least two rows and receives one new row to form a sliding window. Due to such a structure, access to main memory (for example, DRAM) is reduced, and real-time streaming operations become possible in a pipelined CNN accelerator. That is, unlike a layer-by-layer execution method in which results must be stored in main memory and loaded again each time a layer operation ends, a layer-pipeline structure is enabled in which the output of each layer is directly transferred to the next layer. As a result, access to main memory can be greatly reduced, and data can continuously flow like streaming inside the CNN accelerator, enabling real-time pipeline operations.

FIG. 1 is a diagram for explaining a convolution operation using a line buffer in a typical conventional technique.

In FIG. 1, the entire input data to be subjected to the convolution operation and the configuration of a kernel are illustrated. The kernel is a 3×3 kernel, and a convolution operation is performed while the kernel strides to the right. When the convolution operations for each row are all completed, an example is shown in which the kernel moves to the data of the leftmost first coordinate of the next row and strides to the right again.

At this time, several consecutive rows of input data on which convolution will be performed are stored in advance in the line buffer.

For example, the size of the line buffer may be determined according to the following Mathematical Expression.

$${L}_{i} = ( {W}_{i} * ( {kH}_{i} - 1 ) + {kW}_{i} ) * {C}_{in , i} \qquad [ Mathematical Expression 1 ]$$

$${L}_{total} = {\sum }_{i} {L}_{i}$$

This time, Wi denotes the width of an input feature map, Hi denotes the height of the input feature map, Cin,i denotes the number of input channels, and kHi and kWi respectively denote the vertical and horizontal sizes of a kernel.

If the kernel height is kH, at least kH-1 rows of an input feature map must be stored in advance in order to form a kernel window together with the next row, and a total of kH rows may be required simultaneously when including the row currently being processed. Accordingly, the size of a line buffer may be calculated by multiplying the total number of pixels in the horizontal direction (Wi) by the number of channels (Cin,i).

Meanwhile, the following conventional technique is known regarding a method of inputting data into such a line buffer.

FIG. 2 is a diagram illustrating a conventional mapping method of kernel data.

FIG. 2(a) illustrates a channel-first mapping method, in which a kernel storing weights is configured in the form of input channel (Cin)×kernel height (kH)×kernel width (kW). In channel-first mapping, such a three-dimensional kernel is stored in a memory array for in-memory computing based on the channel axis (Cin). However, when the size of a kernel is small or non-uniform, the number of cells actually participating in computation inside the memory array decreases, resulting in a rapid decrease in utilization of the memory array. In addition, when shifting a kernel, data movement between multiple memory arrays is required, leading to a disadvantage in which the data bus becomes longer.

The present invention proposes a new processing apparatus capable of solving such technical problems of the conventional art.

### SUMMARY

### Technical Problem

The present invention has been made to solve the above-described problems of the conventional art, and an objective thereof is to provide a processing apparatus and an operation method capable of performing convolution operations by dividing data according to a pixel-first mapping method.

However, the technical problem to be achieved by the present embodiment is not limited to the technical problem described above, and other technical problems may also exist.

### Means for Solving the Problem

As a technical means for achieving the above-described technical problem, a processing apparatus for accelerating convolution operations according to a first aspect of the present invention comprises: a memory array in which a plurality of elementary processing unit are arranged in an array structure; and an operation unit configured to temporarily store feature-map data, divide the feature-map data into predetermined units along a channel-axis direction according to a pixel-first mapping method, and deliver the divided data to the memory array in a manner of shifting the data according to the position of a kernel.

In addition, an operation method of a processing apparatus for accelerating convolution operations according to a second aspect of the present invention includes: a step of dividing feature-map data on which convolution operations are to be performed into predetermined units along a channel-axis direction according to a pixel-first mapping method and storing the divided data in a line buffer; and a step of performing a convolution operation on the feature-map data stored in the line buffer and kernel data stored in the memory array included in the processing apparatus.

### Effects of the Invention

According to the configuration of the present invention, memory bandwidth can be efficiently utilized by maximizing data reuse through an operation-unit structure that combines a line buffer, shuffle logic, and a register unit. As a result, the number of memory accesses is reduced, thereby alleviating a memory-wall bottleneck and improving the overall operation speed of a system.

In addition, through a design composed of an operation unit and a controller, required bandwidth and data flow can be dynamically adjusted according to various kernel sizes, enabling more efficient use of hardware resources. In particular, adjustment of line-buffer bandwidth according to control signals is designed to support various kernels using the same hardware resources.

Furthermore, in a convolution operation using shift registers and shuffle logic, a complex connection structure such as an all-to-all connection or a barrel shifter is not required, thereby greatly reducing hardware overhead. This enables maintenance of high performance while reducing design complexity and allows implementation of a modular architecture capable of efficiently supporting a large number of kernels.

In addition, an SRAM-based line buffer can be configured to store and utilize feature maps and images of various sizes, and memory resources can be efficiently managed even during padding processing. This minimizes a memory footprint and reduces unnecessary data movement, thereby decreasing power consumption.

Furthermore, the processing apparatus of the present invention has a scalable structure capable of dividing convolution operations according to channel size and processing them in parallel, enabling stable operations without performance degradation even when the array size is expanded. This contributes to meeting real-time processing requirements in various artificial intelligence (AI) applications.

In addition, a line buffer including reconfigurable logic according to the present invention can set hardware according to bandwidth requirements of a kernel, enabling reuse of the same resources even when processing different kernels. As a result, hardware reusability is increased, and overall system cost can be reduced.

### BRIEF DESCRIPTION OF THE DRAWINGS

FIG. 1 is a diagram for explaining a convolution operation using a line buffer in a typical conventional technique.

FIG. 2 is a diagram for explaining a conventional mapping method of kernel data.

FIG. 3 is a diagram for explaining a pixel-first mapping method to be performed in a processing apparatus according to an embodiment of the present invention.

FIG. 4 illustrates a processing apparatus according to an embodiment of the present invention.

FIG. 5 and FIG. 6 are diagrams for explaining a local channel size determined according to a pixel-mapping method according to an embodiment of the present invention.

FIGS. 7A and 7B include a diagram for explaining operations of a register unit of a processing apparatus according to an embodiment of the present invention.

FIGS. 8A to 8D include a diagram visualizing a convolution operation process performed in a processing apparatus according to an embodiment of the present invention.

FIG. 9 illustrates an operation method of a processing apparatus according to an embodiment of the present invention.

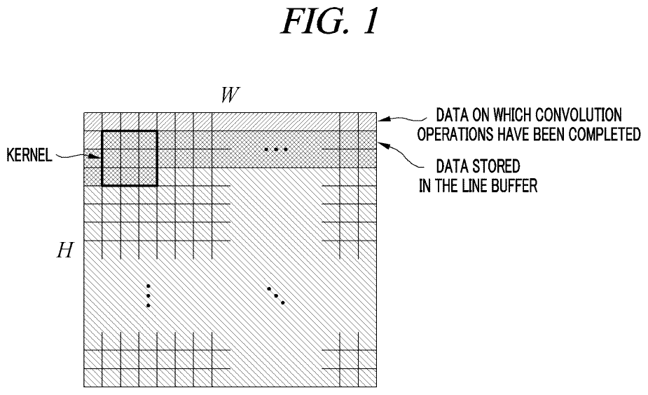

### EMBODIMENTS FOR CARRYING OUT THE INVENTION

With reference to the accompanying drawings, embodiments of the present invention will be described in detail so that those skilled in the art to which the present invention pertains may easily carry out the invention. However, the present invention may be embodied in various different forms and is not limited to the embodiments described herein. In addition, in the drawings, parts irrelevant to the description for clarity of the invention are omitted, and like reference numerals refer to like elements throughout the specification.

Throughout the specification, when a part is described as being “connected” to another part, this includes not only cases in which the part is “directly connected” but also cases in which another element is interposed therebetween and the parts are “electrically connected.” In addition, when a part is described as “including” a component, this means that the part may further include other components unless otherwise specified, and does not exclude other components.

Throughout the present specification, when one member is described as being “on” another member, this includes not only cases where the member is in contact with the other member but also cases where another member exists between the two members.

Hereinafter, preferred embodiments of the present invention will be described in detail with reference to the accompanying drawings and the following description. However, the present invention is not limited to the embodiments described herein and may be embodied in other forms. Throughout the specification, the same reference numerals denote the same components.

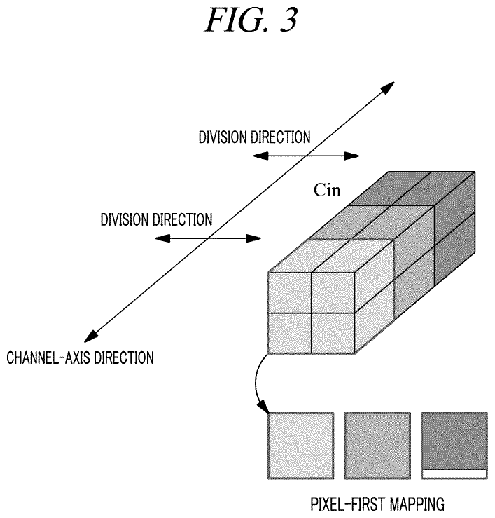

FIG. 3 is a diagram for explaining a pixel-first mapping method to be performed in a processing apparatus according to an embodiment of the present invention.

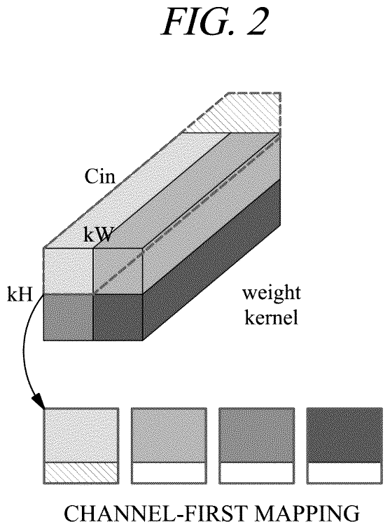

As illustrated, data is arranged on a pixel basis first so as to focus on spatial convolution rather than on channels. Unlike FIG. 2 described above, a concept of dividing data into predetermined groups along an input-channel axis direction (Cin) is applied and mapped to a line buffer or the like. That is, the concept involves dividing data along a division direction intersecting the direction in which the channel axis extends in units of kernel size (kW×kW). In the channel-first mapping of FIG. 2, data was divided on a channel basis and mapped to a line buffer; however, in the pixel-first mapping of FIG. 3, channels are divided in a direction intersecting the channel axis, and data of predetermined divided groups is mapped, thereby differing in configuration. Accordingly, each memory array is mapped to process one spatial pixel block (e.g., a 3×3 window), and local data for each pixel is continuously stored so that operations can continue to be performed in the same array as the kernel moves.

Through this, compared to the conventional method, the cost of data rearrangement during kernel shifting can be reduced, and bitcell utilization of the memory array can be improved.

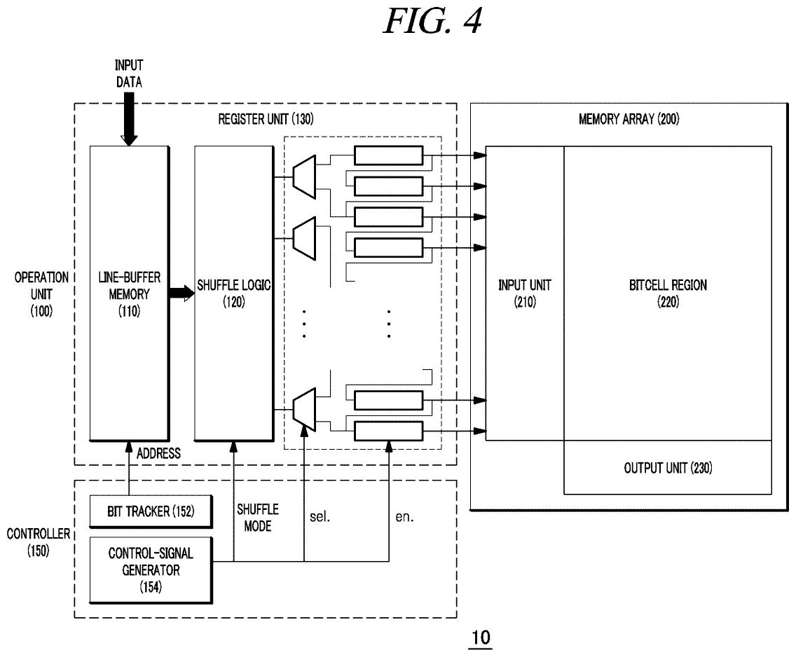

FIG. 4 illustrates a processing apparatus according to an embodiment of the present invention.

A processing apparatus (10) for accelerating convolution operations includes an operation unit (100), a controller (150), and a memory array (200).

The operation unit (100) temporarily stores feature-map data, divides the feature-map data into predetermined units along a channel-axis direction, and delivers the divided data to the memory array (200) in a manner of shifting the data according to the position of a kernel. In this case, not only feature-map data but also kernel data (or weight data) may be stored in the memory array (200) through the operation unit (100). That is, the operation unit (100) may be used to store kernel data in advance in the memory array (200), and feature-map data input later may again be delivered to the memory array (200) through the operation unit (100).

The operation unit (100) may include a line-buffer memory (110) for temporarily storing feature-map data, shuffle logic (120) for rearranging the feature-map data in a manner of shifting the data along a channel direction according to the position of a kernel, and a register unit (130) for shifting the rearranged feature-map data, which is rearranged through the shuffle logic (120), according to the position of a kernel.

In addition, the operation unit (100) may include the controller (150) that controls operations of the operation unit (100).

The controller (150) includes a bit tracker (152) that tracks a position of a bit on which a convolution operation is being performed and delivers address information for the corresponding position to the line-buffer memory (110), and a control-signal generator (154) that outputs shuffle-mode information that is transmitted to shuffle logic (120) and representing a vertical position of a kernel and selection signals (sel, en) for determining which of a plurality of shift registers included in the register unit will receive feature-map data output from the line-buffer memory (110). The shuffle-mode information may include information regarding a row at which the kernel is positioned when the kernel, initially positioned in a horizontal direction, moves to the next row and is positioned in a vertical direction. In addition, the selection signal (sel) may be a signal for selecting a demultiplexer disposed at the front end of a specific shift register. In addition, the selection signal (en) may be a control signal for activating a specific shift register.

Furthermore, the memory array (200) is configured such that a plurality of elementary processing unit are arranged in an array structure, and includes an input unit (210), a bitcell region (220), and an output unit (230). In particular, the plurality of elementary processing unit are arranged in the bitcell region (220). The elementary processing unit may be implemented in the form of CIM (computing-in-memory) units or PE (processing-element) units. An elementary processing unit is a structure that performs both data storage and computation on data, and, for example, a CIM unit stores weight data mainly in a state in which SRAM, DRAM, or non-volatile memory is arranged in an array. The CIM unit mainly performs MAC (Multiply-Accumulate) operations on input data and weight data. Operations are performed on each memory-cell unit, input data is applied through a word line, and results of multiplication between the input data and weight data are output as a current flowing through a bit line. In this case, the bit-line current is a value in which multiplication results of several cells are accumulated, and thus a MAC operation is naturally performed.

The PE unit is a conventional operation unit used in typical CNN accelerators, and is configured to read weight data or kernel data from an external memory or a buffer and perform CNN operations on feature-map data received from the operation unit (100).

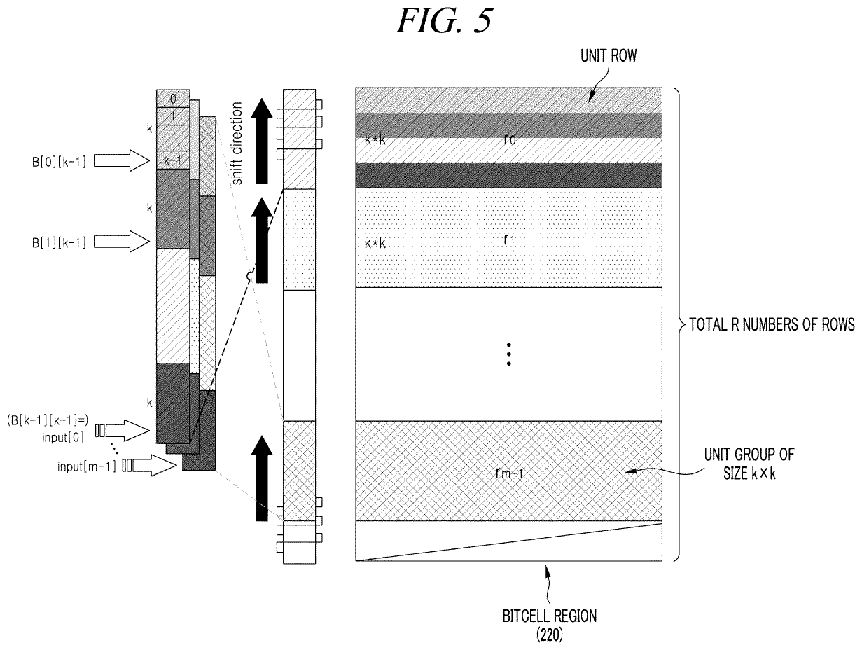

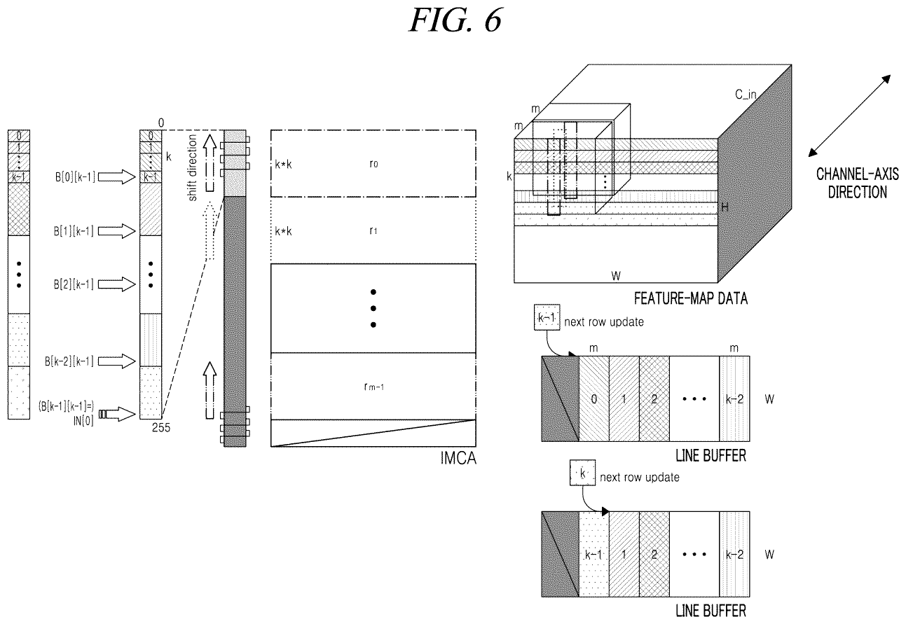

FIG. 5 and FIG. 6 are diagrams for explaining a local channel size determined according to a pixel-first mapping method according to an embodiment of the present invention.

The operation unit (100) distributes kernel data for convolution operations and stores the kernel data in advance in the memory array (200), and divides feature-map data to be convolved with the kernel data into predetermined units along a channel-axis direction and delivers the divided data to the memory array (200).

The operation unit (100) divides channels (Cin) of an input feature map into a local channel size (m) according to pixel-first mapping and performs operations on data of each divided group in the memory array (200). A maximum amount of data that can be operated on in one unit bitcell region of the memory array (200) is defined as the local channel size (m), and may be calculated as in the following Mathematical Expression.

$$m = ⌊ ( R / ( kH \times kW ) ) ⌋ \qquad [ Mathematical Expression 2 ]$$

At this time, R denotes the total number of rows of a unit bitcell region, kH denotes a kernel height, kW denotes a kernel width, and denotes a floor function that discards a fractional part. Accordingly, a quotient obtained by dividing the total number of rows of a unit bitcell region by a spatial size of a kernel is determined as a local channel size.

A more detailed description will be given with reference to the drawings.

First, referring to FIG. 5, when the unit bitcell region (220) has a total of R rows, the local channel size m is determined by dividing the unit bitcell region (220) in units of a kernel size (k×k). Since the size of the unit bitcell region is generally fixed, when the size of a kernel increases, the local channel size decreases, and when the size of a kernel decreases, the local channel size increases. Such a local channel size m may represent the number of data groups that can be simultaneously mapped and operated on in a unit bitcell region.

Meanwhile, FIG. 6 illustrates an extended version of FIG. 5, and particularly illustrates feature-map data of a three-dimensional tensor form. Feature-map data divided in units of a local channel size m along a channel-axis direction (Cin) according to a pixel-mapping method can be identified.

In addition, the operation unit (100) is designed to match a maximum local channel size m that can be processed in a unit bitcell region (220) of the memory array (200), such that one operation unit (100) is matched to each unit bitcell region (220), thereby enabling scalable implementation.

In the line-buffer memory (110), input data (feature-map data) or weight data (kernel data) received from outside is stored according to a pixel-mapping method. The line-buffer memory (110) may be implemented as an SRAM-based memory, but is not necessarily limited thereto.

In addition, multiple rows of feature-map data may be simultaneously stored in the line-buffer memory (110). In this case, the availability of a feature map may be determined by an input-stage size of the memory array (200) and a kernel to be processed. According to a given configuration, a channel group unrolled in a spatial direction of a convolution kernel is mapped to the current memory array (200). When a horizontal length of feature-map data to be processed is W, a local channel size is M, and horizontal and vertical sizes of a kernel are kW and kH, respectively, a size of the line buffer may be set to W×(kH−1)×M. At this time, the line buffer is configured to store W inputs, and has bandwidth of (kH−1)×M so as to read the data, perform shuffling of the data, and then deliver the data to the shift registers. The line buffer includes reconfigurable logic in order to support various kernel sizes. In the present invention, the line buffer is configured so that the same buffer can be maximally reused. In addition, the line buffer sets hardware according to a maximum value of bandwidths to be supported for each kernel, and may use different bandwidths according to control signals received from the controller (150).

The shuffle logic (120) rearranges input data in channel and spatial directions according to spatial positions (kH, kW) of a kernel. The shuffle logic (120) may deliver the same feature-map data to the register unit (130) in different combinations when the kernel moves.

In addition, the shuffle logic (120) supplies feature-map data read from the line-buffer memory (110) to the register unit (130) by shifting values in a channel direction so that the feature-map data can be operated with corresponding kernel weight data. Such shuffle operations occur because, when a kernel moves in a vertical or height direction, a position of a pixel matching the kernel changes. The line buffer stores feature values of different rows in up to k groups, and these positions are predetermined based on modular k. The shuffle logic (120) enables convolution operations of a kernel positioned at different locations by reading the same row through shuffle operations.

The register unit (130) is attached to a front end of the memory array (200) and realizes convolution reuse. In particular, the register unit (130) moves feature-map data in a horizontal direction and enables reuse of the data.

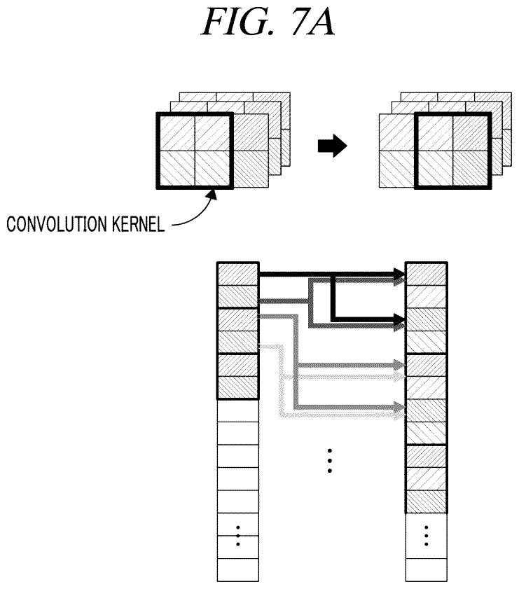

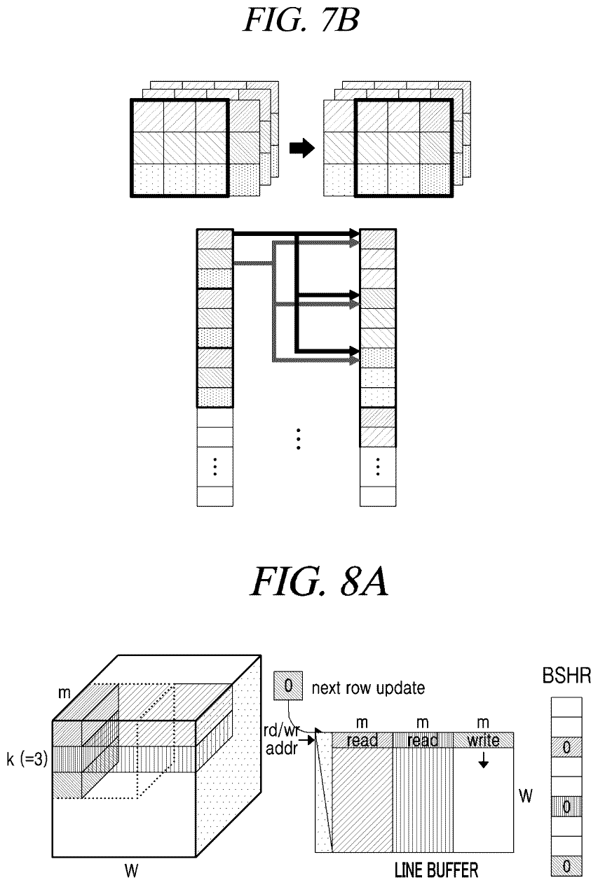

FIG. 7 is a diagram for explaining operations of the register unit (130) of a processing apparatus according to an embodiment of the present invention.
(a) illustrates sliding movement of a 2×2 kernel, and (b) illustrates sliding movement of a 3×3 kernel.
Referring to (b), before the kernel moves, data of a left column and data of a right column among existing feature-map data corresponding to the kernel are all stored in the registers. At this time, as the kernel moves to the right, data of the left column among the existing data is no longer used, data of the right column among the existing data is reused, and new right-column data is added to the registers.
The lower portion of (i) illustrates an arrangement state of shift registers and indicates which index of a shift register is selected as the kernel moves. This may be implemented by a demultiplexer included in the register unit (130). The M×kW×(kH−1) input data previously stored in the register unit (130) is shifted in a given shift direction and reused as next input, thereby realizing convolution reuse in the W direction (horizontal direction). Feature-map data for which reuse ends at a group boundary is shifted out. At this time, depending on types of kernels to be supported (3×3, 5×5, 7×7, etc.), required connectivity for inputs of the shift registers is statically determined. That is, an all-to-all connection or a barrel shifter may not be required.

When new feature-map data corresponding to the kernel illustrated in FIG. 7 is read from the line-buffer memory (110), it can be confirmed that indices of shift registers to which the input is to be connected differ depending on kernel size. To support convolution operations, input connections equal to the kernel height (kH) are required, and in the case of a 2×2 kernel, two demultiplexers (demuxes) are required, whereas in the case of a 3×3 kernel, three demultiplexers are required. By implementing demultiplexers required for each kernel and combining them while excluding duplicated input connections, multiple kernels can be supported simultaneously. For example, to support 2×2 and 3×3 kernels as described above, a 1:4 demultiplexer capable of delivering per-element input data to four shift-register indices may be used, and to support four types of kernels—2×2, 3×3, 5×5, and 7×7—a 1:13 demultiplexer may be employed. Through this, reconfigurable convolution reuse can be realized without significant overhead.

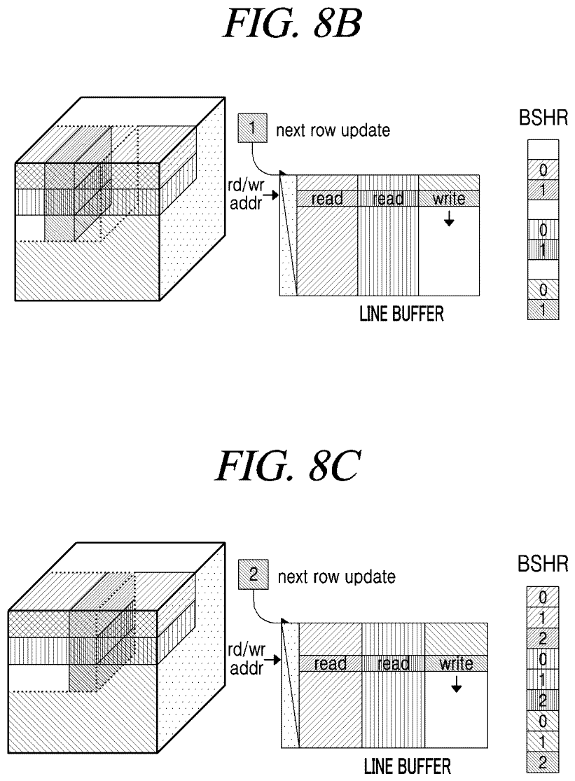

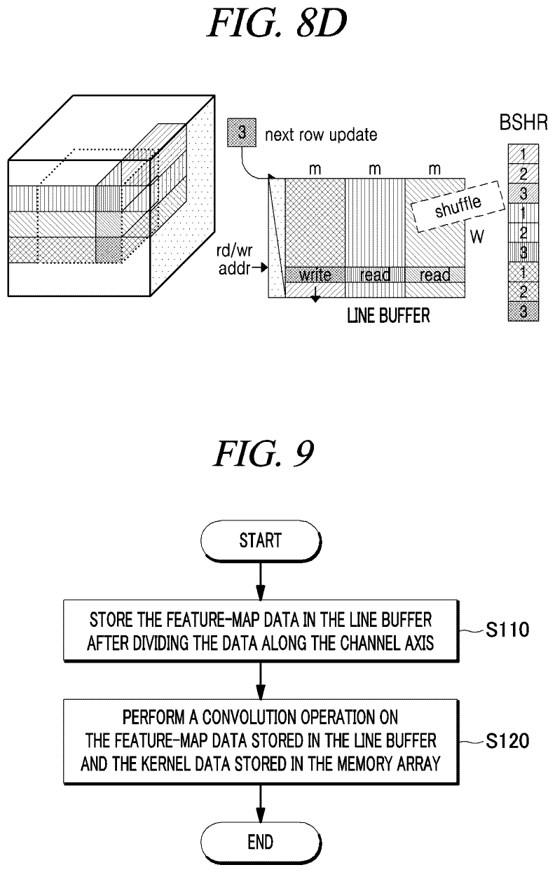

FIG. 8 is a diagram visualizing a convolution operation process performed in a processing apparatus according to an embodiment of the present invention.

In this case, a convolution kernel is set to 3×3. FIGS. (a) to (d) respectively illustrate memory read/write operations and data rearrangement processes through shuffling.

First, referring to FIG. (a), when an initial input feature map is streamed in, the corresponding data is written to the line-buffer memory (110), and previously stored data in the line-buffer memory (110) is read out and stored in the register unit (BSHR, 130). At this time, first-slice kernel data (0, 0, 0) is loaded into a fixed position of the register unit (130) without shuffling through a read operation.

Next, referring to FIG. (b), the first-slice data (0, 0, 0) of FIG. (a) is pushed to the next shift register by the shift logic, and second-slice data (1, 1, 1) is additionally loaded into its place. At this stage as well, memory read and write operations repeat.

Next, referring to FIG. (c), the second-slice data (1, 1, 1) of FIG. (b) is pushed to the next shift register by the shift logic, and third-slice data (2, 2, 2) is added to its place. At this stage as well, memory read and write operations repeat. As all necessary data for a 3×3 convolution kernel is prepared, convolution operations are fully performed in the memory array (200).

Next, referring to FIG. (d), data of the line buffer is rearranged through a shuffle process so that the data is aligned in a format necessary for subsequent operations. Whereas FIGS. (a) to (c) describe data movement while the convolution kernel moves in a horizontal direction, FIG. (d) conceptually illustrates that shuffle operations are performed as the convolution kernel moves in a vertical direction.

FIG. 9 illustrates an operation method of a processing apparatus according to an embodiment of the present invention.

First, as described with reference to FIG. 3, feature-map data to be convolved is divided into predetermined units along a channel-axis direction and stored in the line buffer (110) (S110).

Next, a convolution operation is performed on feature-map data stored in the line buffer (110) and kernel data stored in the memory array (220) included in the processing apparatus (10) (S120).

As described above with reference to FIG. 7 or FIG. 8, prior to performing a convolution operation, the shuffle logic (120) rearranges feature-map data in a manner of shifting the data along a channel direction according to the position of a kernel, and the register unit (130) shifts the rearranged feature-map data according to the position of a kernel.

An embodiment of the present invention may also be implemented in the form of a non-transitory recording medium including computer-executable instructions such as program modules executed by a computer. A computer-readable medium may be any available medium accessible by a computer and includes both volatile and non-volatile media and both removable and non-removable media. A computer-readable medium may also include computer storage media. Computer storage media include all volatile and non-volatile, removable and non-removable media implemented by any method or technology for storage of information such as computer-readable instructions, data structures, program modules, or other data.

Although the method and system of the present invention have been described with reference to specific embodiments, some or all of the components or operations thereof may be implemented using a computer system having a general-purpose hardware architecture.

The above description of the present invention is merely illustrative, and those skilled in the art will understand that various modifications may be made without departing from the technical spirit or essential characteristics of the present invention. Therefore, the embodiments described above should be considered illustrative and not restrictive in all respects. For example, each component described as a single entity may be implemented in a distributed manner, and likewise, components described as distributed may be implemented in a combined manner.

The scope of the present invention is defined by the claims that follow rather than by the foregoing description, and all modifications or variations derived from meanings, ranges, and equivalents of the claims should be construed as being included within the scope of the present invention.

### DESCRIPTION OF REFERENCE NUMERALS

10: processing apparatus
100: operation unit
110: line-buffer memory
120: shuffle logic
130: register unit
150: controller
200: memory array

What is claimed is:

1. A processing apparatus for accelerating convolution operations, comprising:
a memory array in which a plurality of elementary processing unit are arranged in an array structure; and
an operation unit configured to temporarily store feature-map data, divide the feature-map data into predetermined units along a channel-axis direction according to a pixel-first mapping method, and deliver the divided data to the memory array in a manner of shifting the data according to a position of a kernel.

2. The processing apparatus according to claim 1,
wherein the operation unit comprises:
a line-buffer memory in which the feature-map data is temporarily stored;
shuffle logic configured to rearrange the feature-map data in a manner of shifting the data along a channel direction according to a position of a kernel; and
a register unit configured to shift the feature-map data rearranged through the shuffle logic according to the position of the kernel.

3. The processing apparatus according to claim 2,
further comprising a controller configured to control operations of the line-buffer memory, the shuffle logic, and the register unit,
wherein the controller comprises:
a bit tracker configured to track a position of a bit on which a convolution operation is being performed and deliver address information for the corresponding position to the line-buffer memory; and
a control-signal generator configured to output shuffle-mode information transmitted to the shuffle logic and representing a vertical position of the kernel, and a selection signal for determining which of a plurality of shift registers included in the register unit will receive feature-map data output from the line-buffer memory.

4. The processing apparatus according to claim 1,
wherein a convolution operation is performed on the feature-map data stored in the line buffer and kernel data stored in elementary processing unit included in the memory array.

5. The processing apparatus according to claim 1,
wherein the operation unit defines a local channel size (m) as a maximum amount of data that can be operated on in one unit bitcell region of the memory array,
and the local channel size is determined by a quotient obtained by dividing a total number of rows of the unit bitcell region by a spatial size of a kernel.

6. A method of operating a processing apparatus for accelerating convolution operations, comprising:
dividing feature-map data to be convolved into predetermined units along a channel-axis direction according to a pixel-first mapping method, and storing the divided data in a line buffer; and
performing a convolution operation on the feature-map data stored in the line buffer and kernel data stored in a memory array included in the processing apparatus.

7. The method according to claim 6,
wherein a local channel size (m) is defined as a maximum amount of data that can be operated on in one unit bitcell region of the memory array,
and the local channel size is determined by a quotient obtained by dividing a total number of rows of the unit bitcell region by a spatial size of a kernel.
